(19) United States
(12) Patent Application Publication
(10) Pub. No.: US 2017/0235726 A1
(43) Pub. Date: Aug. 17, 2017

(54) INFORMATION IDENTIFICATION AND EXTRACTION

(71) Applicant: FUJITSU LIMITED, Kawasaki-shi (JP)

(72) Inventors: Jun WANG, San Jose, CA (US); Kanji UCHINO, Santa Clara, CA (US)

(73) Assignee: FUJITSU LIMITED, Kawasaki-shi (JP)

(21) Appl. No.: 15/043,406

(22) Filed: Feb. 12, 2016

(51) Int. Cl. G06F 17/30

(52) U.S. Cl. CPC G06F 17/30011; G06F 17/30867; G06F 17/3053

(57) ABSTRACT

A computer implemented method of information identification and extraction may include creating an author object in a database for each author of multiple digital documents. For each author object created, the computer implemented method may also include obtaining an indication of social media accounts in a social media based on a search in the social media for a name of the author in the author object. Alternately or additionally, for each social media account obtained through the search of the social media, the method may include determining whether the social media account is associated with the author of the author object based on two or more of the following: a name score, a profile score, a content score, and an interaction score.

### FIELD

The embodiments discussed herein are related to information identification and extraction.

### BACKGROUND

With the advent of computer networks, such as the Internet, and the growth of technology more and more information is available to more and more people. For example, many leading researchers are sharing information and exchanging ideas timely using social media.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a computer implemented method of information identification and extraction may include creating an author object in a database for each author of multiple digital documents. For each author object created, the computer implemented method may also include obtaining an indication of social media accounts in a social media based on a search in the social media for a name of the author in the author object. Alternately or additionally, for each social media account obtained through the search of the social media, the method may include determining whether the social media account is associated with the author of the author object based on two or more of the following: a name score, a profile score, a content score, and an interaction score.

In some embodiments, the name score may be generated based on a comparison of a name from the author object and a social media name from a social media account object generated based on the social media account. In some embodiments, the profile score may be generated based on a comparison of author profile data from the author object and social media profile data from the social media account object. In some embodiments, the content score may be generated based on a comparison of topics from postings on the social media account and topics for each of the digital documents associated with the author from the author object. In some embodiments, the interaction score may be generated based on an evaluation of social connections in the social media account and co-authors for each of the digital documents associated with the author from the author object.

The object and advantages of the embodiments will be realized and achieved at least by the elements, features, and combinations particularly pointed out in the claims.

It is to be understood that both the foregoing general description and the following detailed description are merely examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example system configured to identify and extract information;

FIG. 2 is a diagram of an example flow that may be used with respect to information identification and extraction;

FIGS. 3a and 3b illustrate a flowchart of an example method of information identification and extraction;

FIG. 4 illustrates a flowchart of another example method of information identification and extraction;

FIG. 5 illustrates a flowchart of another example method of information identification and extraction; and

FIG. 6 illustrates an example system that may identify and extract information.

### DESCRIPTION OF EMBODIMENTS

Some embodiments described herein relate to methods and systems of information identification and extraction. The current fast-pace of technology, research, and general knowledge creation has resulted in previous and current methods of knowledge dissemination not adequately providing up-to-date knowledge and information on recent developments. What is more, knowledge is no longer generated by a few select individuals in select regions. Rather, researchers, professors, experts, and others with knowledge of a given topic, referred to in this disclosure as knowledgeable people, are located around the world and are constantly generating and sharing new ideas.

As a result of the Internet, however, this vast wealth of newly created knowledge from around the world is being shared worldwide in a continuous manner. In some circumstances, this vast knowledge is being shared through social media. For example, knowledgeable people may share knowledge recently acquired through blogs, micro-blogs, and other social media.

Knowing that current information is being shared on social media does not result in the current information being readily accessible or that an individual could realistically access the information. In some fields, there may be thousands, tens of thousands, or hundreds of thousands of knowledgeable people. There is no database that includes the names of knowledgeable people from a specific field. However, even if a database included the names, the time spent for a person to determine if the knowledgeable people have social media accounts would be unreasonable for anyone to consider. Furthermore, even if a person could determine if a knowledgeable person had a social media account, the time to continually access and parse through the social media accounts to obtain the new knowledge shared therein would be unrealistic.

In short, due to the rise of computers and the Internet, mass amounts of information is available, but there is no realistic way for a person to reasonably access the information. Some embodiments described herein relate to methods and systems of information identification and extraction that may help people to access the information that was either previously unavailable or not reasonably obtainable by a human or even a group of humans without the aid of technology.

The methods and systems of information identification and extraction described in this disclosure include determining knowledgeable people by determining authors of publications and lectures. Metadata about the multiple authors is extracted from the publications and lectures. The author metadata is used to search social media accounts to determine the social media accounts of the authors. For example, in some embodiments, the author metadata may include information about the author's name, a profile of an author, and co-authors. The information from the social media accounts may be compared to the author metadata to match the authors to the social media accounts. In some embodiments, the systems and method in this disclosure may further consider the topic of information provided on the social media accounts. Thus, if an author has a social media account, but does not share knowledge related to the topic for which the author has published, the social media account may not be considered.

After identifying the social media accounts, information on the identified social media accounts may be collected, organized, and presented. For example, the information may be organized based on topics such that a person interested in a selected topic could be presented with the current knowledge from multiple different knowledgeable people with current updates. In this manner, new information from a number of sources that could not reasonably be identified or managed by a person may be accessed and shared. Thus, the system and methods in this disclosure provide a technical solution to a problem that arises from technology that could not reasonably be performed by a person.

Embodiments of the present disclosure are explained with reference to the accompanying drawings.

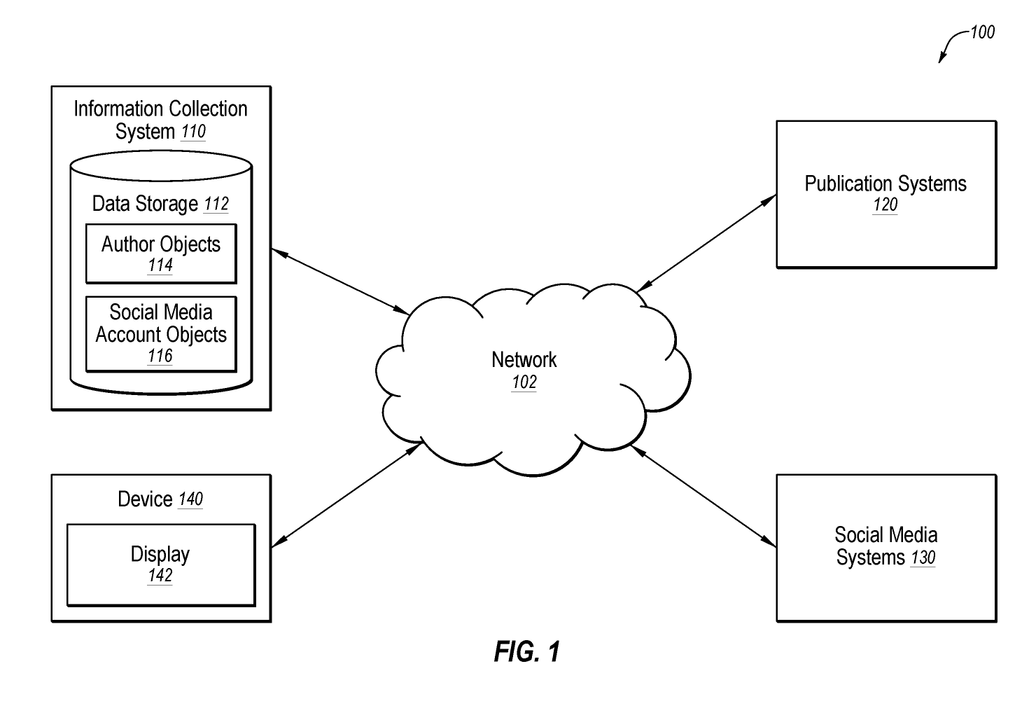

FIG. 1 is a diagram representing an example system 100 configured to test software, arranged in accordance with at least one embodiment described in the disclosure. The system 100 may include a network 102, an information collection system 110, publication systems 120, social media systems 130, and a device 140.

The network 102 may be configured to communicatively couple the information collection system 110, the publication systems 120, the social media systems 130, and the device 140. In some embodiments, the network 102 may be any network or configuration of networks configured to send and receive communications between devices. In some embodiments, the network 102 may include a conventional type network, a wired or wireless network, and may have numerous different configurations. Furthermore, the network 102 may include a local area network (LAN), a wide area network (WAN) (e.g., the Internet), or other interconnected data paths across which multiple devices and/or entities may communicate. In some embodiments, the network 102 may include a peer-to-peer network. The network 102 may also be coupled to or may include portions of a telecommunications network for sending data in a variety of different communication protocols. In some embodiments, the network 102 may include Bluetooth® communication networks or cellular communication networks for sending and receiving communications and/or data including via short message service (SMS), multimedia messaging service (MMS), hypertext transfer protocol (HTTP), direct data connection, wireless application protocol (WAP), e-mail, etc. The network 102 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 102 may include one or more IEEE 802.11 wireless networks.

In some embodiments, any one of the information collection system 110, the publication systems 120, and the social media systems 130, may include any configuration of hardware, such as servers and databases that are networked together and configured to perform a task. For example, the information collection system 110, the publication systems 120, and the social media systems 130 may each include multiple computing systems, such as multiple servers, that are networked together and configured to perform operations as described in this disclosure. In some embodiments, any one of the information collection system 110, the publication systems 120, and the social media systems 130 may include computer-readable-instructions that are configured to be executed by one or more devices to perform operations described in this disclosure.

The information collection system 110 may include a data storage 112. The data storage 112 may be a database in the information collection system 110 with a structure based on data objects. For example, the data storage 112 may include multiple data objects with different fields. In some embodiments, the data storage 112 may include author objects 114 and social media account objects 116.

In general, the information collection system 110 may be configured to obtain author information of publications, such as articles, lectures, and other publications from the publication systems 120. Using the author information, the information collection system 110 may determine social media accounts associated with the authors and pull information from the social media accounts from the social media systems 130. The information collection system 110 may organize and provide the information from the social media accounts to the device 140 such that the information may be presented on a display 142 of the device 140.

The publication systems 120 may include multiple systems that host articles, publications, journals, lectures, and other digital documents. The multiple systems of the publication systems 120 may not be related other than they all host media that provides information. For example, one system of the publication systems 120 may include a university website that host lectures and papers of a professor at the university. Another of the publication systems 120 may be a website that host articles published in journals. In these and other embodiments, the publication systems 120 may not share a website, a server, a hosting domain, or an owner.

In some embodiments, the information collection system 110 may access one or more of the publication systems 120 to obtain digital documents from the publication systems 120. Using the digital documents, the information collection system 110 may obtain information about the authors of the digital documents and topics of the digital documents. In some embodiments, for each author of a digital document, the information collection system 110 may create an author object 114 in the data storage 112. In the created author object 114, the information collection system 110 may store information about the author obtained from the digital document. The information may include a name, profile, an image, and co-authors of the digital document. The information collection system 110 may also determine topics of the digital document. The topics of the digital document may be stored in the author object 114.

In some embodiments, multiple digital documents from the publication systems 120 may include the same author. In these and other embodiments, the author object 114 for the author may be updated and/or supplemented with information from the other digital documents. For example, the topics from the other digital documents may be stored in the author object 114. In some embodiments, the topics of all of the digital documents of an author obtained by the information collection system 110 may be stored in the author object 114.

After creating the author objects 114, the information collection system 110 may be configured to determine social media accounts for each of the authors in the author objects 114. The information collection system 110 may determine social media accounts by accessing the social media systems 130.

In some embodiments, each of the social media systems 130 may be a system configured to host a different social media. For example, one of the social media systems 130 may be a microblog social media system. Another of the social media systems 130 may be a blogging social media system. Another of the social media systems 130 may be a social network or other type of social media system.

The information collection system 110 may request each of the social media systems 130 to search its respective social media accounts for the names of each author in the author objects 114. For example, the information collection system 110 may include thousands, tens of thousands, or hundreds of thousand author objects 114, where each author objects 114 includes the name of one author. In this example, there may be four social media systems 130 in which authors may share information. The number of social media systems 130 may be more of less than four. In these and other embodiments, the information collection system 110 may request a search be performed in each of the four social media systems 130 using the name of the author associated with each author objects 114. Thus, if there were four social media systems 130 and 100,000 authors, then the information collection system 110 would request 400,000 searches. The social media systems 130 may provide the results of the searches to the information collection system 110. In these and other embodiments, the results of the searches may be links and/or network addresses of social media accounts with an owner that has a name that at least partially matches the names of the authors of the author objects 114.

Using the links and/or network addresses of the social media accounts from the search, the information collection system 110 may request the social media accounts. The information collection system 110 may also create a social media account object 116 for each of the social media accounts. To create the social media account objects 116, the information collection system 110 may pull information from the social media accounts and store the information in the social media account objects 116. The social media account objects 116 may include information about the person associated with the social media account, such as a name, profile data, image, and social media contacts. The information collection system 110 may also obtain topics of the posts in the social media accounts which may also be stored in the social media account objects 116.

The information collection system 110 may compare the information from the author objects 114 with the information from the social media account objects 116 to determine the social media accounts associated with the authors in the author objects 114. For example, for a given author object 114, the search of the social media systems 130 may result in twenty-five accounts. The social media account objects 116 of the twenty-five accounts may be compared to the given author object 114 to determine which of the twenty-five accounts is associated with the author of the given author object 114. In some embodiments, an author may be associated with a social media account when the author is the owner of the social media account.

After matching social media accounts with authors from the digital documents from the publication systems 120, the information collection system 110 may obtain information from the matching social media accounts. In these and other embodiments, the information collection system 110 may request the social media accounts and parse the social media accounts to obtain the information from the social media accounts. The information collection system 110 may collate the information from the social media accounts and organize the information based on topics to provide the information to users of the information collection system 110. For example, the information collection system 110 may provide the information to the device 140.

The device 140 may be associated with a user of the information collection system 110. In these and other embodiments, the device 140 may be any type of computing system. For example, the device 140 may be a desktop computer, tablet, mobile phone, smart phone, or some other computing system. The device 140 may include an operating system that may support a web browser. Through the web browser, the device 140 may request webpages from the information collection system 110 that include information collected by the information collection system 110 from the social media accounts of the social media systems 130. The requested webpages may be displayed on the display 142 of the device 140 for presentation to a user of the device 140.

Modifications, additions, or omissions may be made to the system 100 without departing from the scope of the present disclosure. For example, the system 100 may include multiple other devices that obtain information from the information collection system 110. Alternately or additionally, the system 100 may include one social media system.

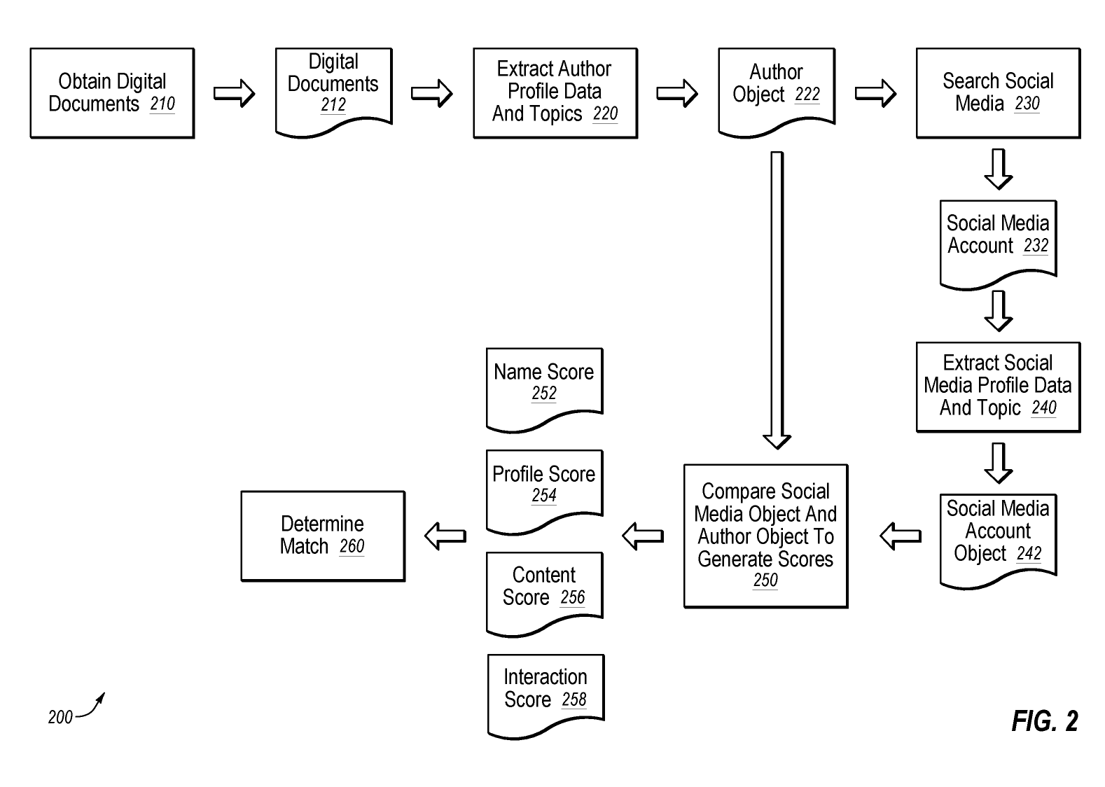

FIG. 2 is a diagram of an example flow 200 that may be used to identify and extract information, according to at least one embodiment described herein. In some embodiments, the flow 200 may be configured to illustrate a process to identify and extract information from social media accounts. In particular, the flow 200 may be configured to determine if a social media account is associated with an author of a digital document. In these and other embodiments, a portion of the flow 200 may be an example of the operation of the system 100 of FIG. 1.

The flow 200 may begin at block 210, wherein digital documents 212 may be obtained. The digital documents 212 may be obtained from one or more sources, such as websites and other sources. The digital documents 212 may be a publication, lecture, article, or other document. In some embodiments, the digital documents 212 may be a recent document, such as document released within a particular period, such as within the last week, month, or several months.

At block 220, author profile data and topics of all or some of the digital documents 212 may be extracted using methods such as topic model analysis. Author profile data about an author in one or more of the digital documents 212 may be extracted and stored in an author object 222. In some embodiments, the author profile data may include a full name of the author, an affiliation of the author, title of the author, co-authors, a document image of the author, and an expertise or interest description of the author. The affiliation of the author may relate to the business, university, or other entity, with which the author affiliates. The title of the author may include a rank or position of the author. For example, the author may have the title of doctor, research manager, senior researcher, professor, lecturer etc. To extract the author profile data, the digital documents 212 may be parsed and searched for keywords associated with the author profile data.

In some embodiments, a topic model analysis may be performed on the digital documents 212. In some embodiments, the topic model analysis may include a number of topics that may be determined and the digital documents 212 may be analyzed to determine which of the topics are in the digital documents 212. In these and other embodiments, the topic model analysis may output a word distribution from the digital documents 212 for each of the topics. Alternately or additionally, a topic distribution for each of the digital documents 212 may be determined. Thus, it may be determined the topics for each of the digital documents 212. Note that in some embodiments, one or more of the digital documents 212 may include multiple topics. In some embodiments, the topics for each of the digital documents 212 may be stored in the author object 222.

At block 230, social media may be searched for the author from the author object 222. In some embodiments, the social media may be searched using the full name of the author. The search for the author may result in a social media account 232 that may be owned, operated by, or associated with the author of the digital document 212.

At block 240, social media profile data may be extracted from the social media account 232. The social media profile data may be similar to the author data. For example, the social media profile data may include information about the person that owns, operates, or is associated with the social media account. The person that owns, operates, or is associated with the social media account may be referred to as a social media account owner. The social profile data may include a name, affiliations, locations, titles, expertise, a social media image, or interest description, and other information about the social media account owner. In some embodiments, the social profile data may be collected by parsing and analyzing words from the social media account that is not a posting on the social media account, such as a biography, profile, or other information about the person that owns the social media account.

In some embodiments, a number of social media accounts connected to the social media account 232 may be determined. Alternately or additionally, the social media account owners of the social media accounts connected to the social media account 232 may be identified. In some embodiments, a number of social media accounts mentioned by the social media account 232 may be determined. Alternately or additionally, the social media account owners of the social media accounts mentioned by the social media account 232 may be identified. The information about the number of owner connected and/or mentioned in the social media account 232 may be part of social media interaction data.

In some embodiments, the expertise of the social media account owners for one or more of the social media accounts mentioned or connected to the social media account 232 may be determined. In these or other embodiments, the mentioned or connected social media accounts may be accessed. The expertise of the mentioned or connected social media accounts owners may be determined. In some embodiments, the expertise may be determined based on a description in a profile of the social media accounts owners. Alternately or additionally, the expertise may be determined based on the topics of the postings of the mentioned or connected social media accounts.

In some embodiments, topics of the postings on the social media account 232 may also be determined. To determine the topics of the postings, the postings shorter than a threshold number of words may be removed. The threshold number of words may depend on the form of the social media. For example, if the social media is a microblog, the threshold number may be smaller than the threshold number for a blog.

In addition to the postings on the social media account 232, content linked by the postings on the social media account 232 may be used to determine the topics or topic of the social media account 232. In these and other embodiments, the links within the postings of the social media account 232 may be accessed and the content collected. In particular, links within postings of social media accounts 232 that are micro blogs may be accessed and content collected. The collected content and the postings may be aggregated. A topic model analysis may be applied to determine topic distributions of the aggregated content. Using the topic model, topic distribution of the social media account 232 may be determined. In some embodiments, the authors of the content collected from the links in the postings of the social media account 232 may also be collected. The social media profile data, social media interaction data, and topics may be stored as the social media account object 242.

At block 240, the social media account object 242 associated with the social media account 232 that results from a search using the name of an author from the author object 222 is compared to the author object 222 to generate various scores. The scores include a name score 252, a profile score 254, a content score 256, and an interaction score 258.

The name score 252 may be determined based on comparison of the name from the author object 222 and the name from the social media account object 242. If the names fully match, the name score 252 may be a first value. If the names partially match, the name score 252 may be a second value, and if abbreviation of the names match, the name score 252 may be a third score. If there is not a match between the names, the name score 252 may be zero. The values for the first, second, and third scores may be determined based on ad-hoc heuristic rules or statistical machine learning.

The profile score 254 may be determined based on a comparison of one or more of the following from the author object 222 and the social media account object 242: title, affiliation, expertise description, image, and location. In these and other embodiments, the location of the author from the author object 222 and the location of the social media account owner from the social media account object 242 may be inferred from their respective affiliations. In these and other embodiments, the titles, the affiliations, the images, the expertise description, and the locations of the author and the social media account owner may be compared.

In some embodiments, the document image from the author object 222 may be analyzed using a facial recognition algorithm. For example, the document image from the author object 222 may be an image of the author. The social media image from the social media account object 242 may also be analyzed using a facial recognition algorithm. For example, the social media image from the social media account object 242 may be an image of the owner of the social media account 232. In some embodiments, the results from the analysis of the document image from the author object 222 may be compared with the results from the analysis of the social media image from the social media account object 242. The comparison may provide an indication of the likelihood that the images include the same person. The indication of the likelihood that the images include the same person may be used to generate the profile score 254.

In some embodiments, the title, the affiliations, the expertise description, the analysis of the document image, and the location from the author object 222 may be placed in an author profile vector. Similarly, the title, the affiliations, the expertise description, the analysis of the social media image, and the location from the social media account object 242 may be placed in a social media account profile vector. The author profile vector and the social media profile vector may be compared using vector space modeling. The result of the vector space modeling may be the profile score 254. In some embodiments, the profile score 254 may be based on another compilation of the comparisons between the title, affiliation, expertise, and location. For example, each comparison may be given the same or different weight and then the scores of the comparison added together in a linear combination.

The content score 256 may be determined based on a comparison of the topic of the digital documents 212 associated with the author from the author object 222 and the main topic of the social media account from the social media account object 242. In some embodiments, the content score 256 may be increased when an author of the content that was linked in the postings matches the author and/or co-authors from the author object 222.

In some embodiments, to compare the topic of the digital documents 212 associated with the author and the main topic of the social media account from the social media account object, each of the digital documents 212 associated with the author may be presented in a bag-of-words vector. A centroid vector of digital documents 212 associated with the author may be determined using an average of the bag-of-words vectors for the digital documents 212. In some embodiments, each posting from the social media account 232 may also be presented as a bag-of-words vector. A centroid vector of all of the postings of the social media account 232 may be determined using an average of all the bag-of-words vectors for the postings. A vector space model may be used to calculate a similarity score S_bow, between the centroid vector of the postings of the social media account 232 and the centroid vector of the digital documents 212 of the author object 222.

In some embodiments, the topic distribution of all of the digital documents 232 of the author may be used to form an author topic vector. A topic distribution of all of the postings from a social media account 232 may be used to form a posting topic vector. A vector space model may be used calculate a similarity score S_topic, between the author topic vector and the posting topic vector. A number of times when the author from the author object 212 is also the authors of a document extracted from a link embedded in postings of the social media account may be a number N_author. In some embodiments, the content score may be represented by the following equation: a*S_bow+b*S_topic+c*log(N_author+1), where a, b, c are numbers and a+b+c=1.

The interaction score 258 may be determined based on a correlation between the co-authors of the digital document 212 and the social media account owners of the social media accounts connected and mentioned in the social media account 232. In these and other embodiments, a number of the social media account owners that are mentioned in the social media account 232 that are co-authors may be determined and be referred to as a mentioned account number. A number of the social media accounts owners that are connected to the social media account 232 that are co-authors may also be determined and be referred to as a connected account number. In some embodiments, the interaction score 258 may be a linear combination of the mentioned account number and the connected account number. In some embodiments, each of the mentioned account number and the connected account number may be weighted differently. The weights for the mentioned account number and the connected account number may be determined based on ad-hoc heuristic rules and statistical machine learning.

In some embodiments, the interaction score 258 may be determined based on the mentioned account number, the connected account number, and an average expertise score and/or content score of the other social media account owners of the connected and mentioned social accounts compared with the expertise of the author.

For example, in some embodiments, the number of connected social media accounts identified as co-authors may be represented as N_connected. A number of mentioned social media accounts identified as co-authors may be represented as N_mentioned. The average expertise score and/or content score between other connected social accounts and the author may be represented as S_average_connected. An average expertise score and/or content score between other mentioned social accounts and the author may be represented by S_average_mentioned.

In these and other embodiments, the interaction score 258 may be based on the following equation: P1*log(N_connected+1)+P2*log(N_mentioned+1)+P3*S_average_connected+P4*S_average_mentioned, where P1, P2, P3, and P4 are numbers and P1+P2+P3+P4=1.

At block 260, it may be determined if the social media account owner of the social media account 232 is the same as the author from the author object 222 using the name score 252, the profile score 254, the content score 256, and the interaction score 258. In some embodiments, the determination may be made based on a linear combination of the name score 252, the profile score 254, the content score 256, and the interaction score 258. For example, when the linear combination of the name score 252, the profile score 254, the content score 256, and the interaction score 258 is above a threshold, it may be determined that the social media account owner of the social media account 232 is the same as the author from the author object 222. In some embodiments, the threshold may be determined based on previous authentication of matches. For example, multiple iterations of the flow 200 may be determined for different authors and the matches determined outside of the flow 200. A threshold score with a particular confidence may be selected based on the multiple iterations.

In some embodiments, each of the name score 252, the profile score 254, the content score 256, and the interaction score 258 may be weighted differently. In these and other embodiments, the weights for the different scores may be determined using statistical machine learning or some other algorithm. For example, a machine learning algorithm may be trained based on predetermined matches and non-matches. After being trained, the machine learning algorithm may receive as an input each of the individual scores, may weight and linearly combine the scores, and may determine the likelihood that the social media account owner of the social media account 232 is the same as the author from the author object 222. In some embodiments, when the likelihood that the social media account owner of the social media account 232 is the same as the author from the author object 222 and is above a threshold the machine learning algorithm may indicate that there is a match. In some embodiments, the threshold may be user selected or otherwise determined based on previous experience or iterations of the flow 200.

Modifications, additions, or omissions may be made to the flow 200 without departing from the scope of the present disclosure. For example, in some embodiments, the flow 200 may include multiple social media accounts 232. In these and other embodiments, a social media account object 242 may be created for each social media account 232 and the author object 222 may be compared to each social media account object 242 individually to determine a match. In some embodiments, if the author is determined to be the social media account owner of the single social media account 232, then no other social media account objects 242 may be created for the social media accounts 232 resulting from the search for the author.

In some embodiments, the social media account objects 242 for each of the different social media accounts 232 may be determined before comparisons to the author object 222. Alternately or additionally, the social media account object 242 of a single social media account 232 may be created and then compared to the author object 222 associated with the author that resulted in the single social media account 232, the scores generated, and a match determined before other social media account objects 242 are created.

In some embodiments, the digital documents 212 may include multiple authors. In these and other embodiments, author profile data about each of the authors may be collected and used to generate different author objects 222. A search for social media for each of the different author objects 222 may occur. In short, the flow 200 is merely one example of data flow for information identification and extraction and the present disclosure is not limited to such.

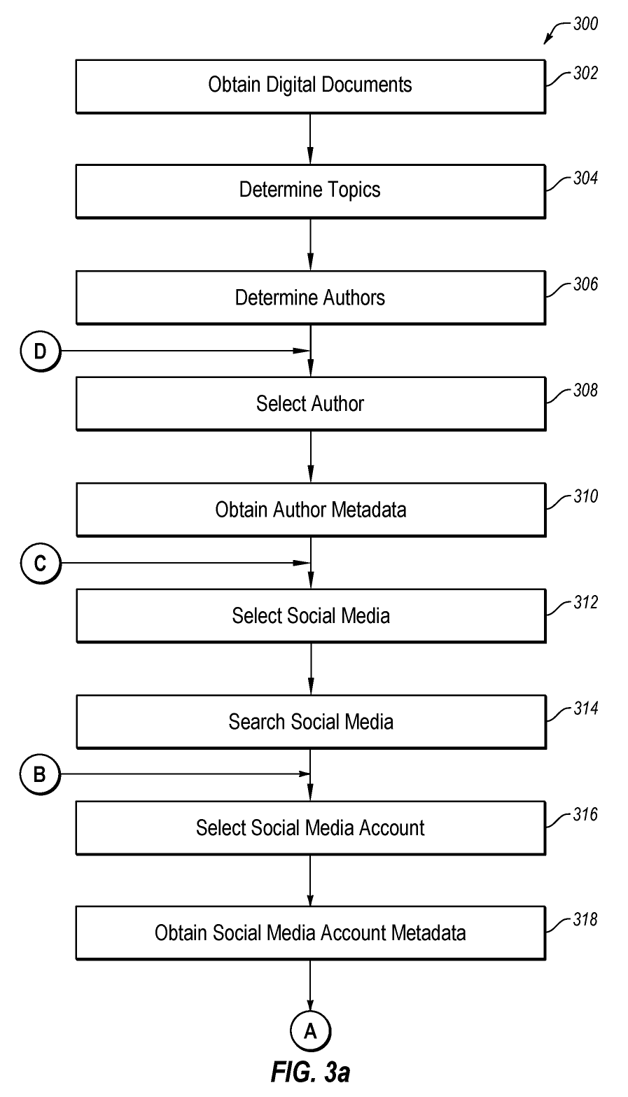

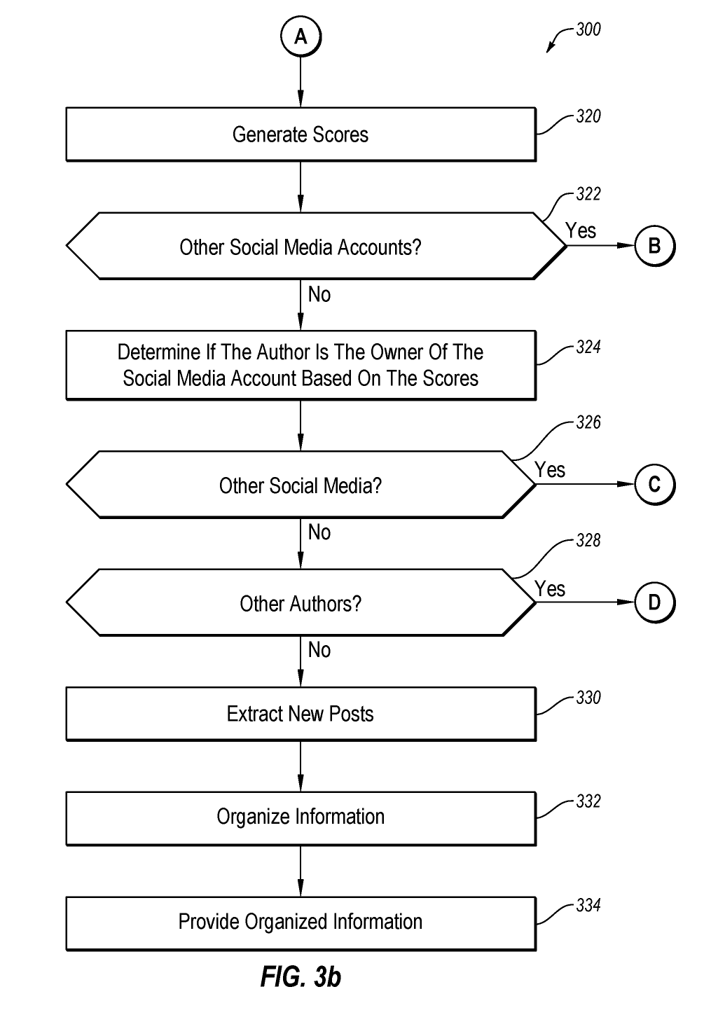

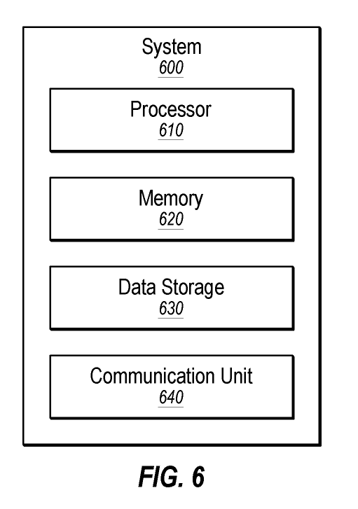

FIGS. 3a and 3b illustrate a flowchart of an example method 300 of information identification and extraction, according to at least one embodiment described herein. In some embodiments, one or more of the operations associated with the method 300 may be performed by the information collection system 110. Alternately or additionally, the method 300 may be performed by any suitable system, apparatus, or device. For example, the processor 610 of the system 600 of FIG. 6 may perform one or more of the operations associated with the method 300. Although illustrated with discrete blocks, the steps and operations associated with one or more of the blocks of the method 300 may be divided into additional blocks, combined into fewer blocks, or eliminated, depending on the desired implementation.

The method 300 may begin at block 302 where multiple digital documents may be obtained from one or more sources using a processing system. The digital documents may be recent documents, such as documents released within a particular recent time period, such as within the last week, month, or several months. At block 304, topics of each of the digital documents may be determined using a topic model analysis.

At block 306, authors of the digital documents may be determined. In some embodiments, determining the authors may include extracting the names of the people indicated as authors in the digital documents. In these and other embodiments, the digital documents may be parsed and searched for words indicating that a name is an author of the digital document. In some embodiments, an author object may be obtained for each author from a database. In some embodiments, obtaining the author object may include creating the author object or searching and locating an existing author object in the database with the same name.

At block 308, an author may be selected. At block 310, metadata about the selected author may be obtained. In some embodiments, the metadata may be obtained from the digital documents that include the author. In some embodiments, the metadata may be author profile data and a topic of the digital documents that include the author. The metadata may be saved in an author object associated with the author.

At block 312, a social media may be selected. At block 314, the selected social media may be searched using the name of the selected author. The search may result in multiple social media accounts that may be associated with the author. At block 316, one of the social media accounts may be selected.

At block 318, social media account metadata of the selected social media account may be obtained. In some embodiments, the social media account metadata may be obtained from the selected social media account. In some embodiments, the social media account metadata may be social media account profile data and a topic or topics of the posts, linked documents, and other aspects of the selected social media account. The social media account metadata may be saved in an author object associated with the selected social media account.

At block 320, scores may be generated based on a comparison between the selected social media account and the selected author. In some embodiments, the scores may be generated based on a comparison of the social media account object and the author object. In some embodiments, the scores may include one or more of a name score, a profile score, a content score, and an interaction score.

At block 322, it may be determined if there are other social media accounts that resulted from the search of the social media at block 314 that have not been selected. When there are other non-selected social media accounts, the method 300 may proceed to block 316 where another of the non-selected social media accounts may be selected. When there are no other non-selected social media accounts, the method 300 may proceed to block 324.

At block 324, it may be determined if the selected author is a social media account owner of the selected social media accounts using the scores generated for each of the social media accounts at block 320. In some embodiments, it may be determined which of the social media account owners of the selected social media accounts is the selected author by comparing the scores generated for each of the social media accounts. In these and other embodiments, the social media account with the highest score may be determined to be the social media account of the selected author. Alternately or additionally, the social media accounts with scores higher than a selection threshold may be determined to be the social media accounts of the selected author. The selection threshold may be based on machine learning, previous experience, among other types of analysis. If the selected author is the social media account owner of one of the selected social media accounts, the selected author and the one of the selected social media accounts may be associated in the database that includes the author objects and the social media account objects.

At block 326, it may be determined if there are other social media that have not been selected at block 312. For example, the method 300 may be configured to match authors with social media accounts in multiple different social medias. When there are other non-selected social medias, the method 300 may proceed to block 312 where another of the non-selected social medias may be selected. When there are no other non-selected social medias, the method 300 may proceed to block 328.

At block 328, it may be determined if there are other authors from the digital documents that were determined at block 306 that have not been selected. When there are other non-selected authors, the method 300 may proceed to block 308 where another of the non-selected authors may be selected. When there are no other non-selected authors, the method 300 may proceed to block 330.

At block 330, new posts on the social media accounts that are associated with the authors in the database may be extracted. To extract the new posts, the database may include a network address for the social media accounts. A system may navigate to the social media accounts using the network address and extract the posts from a recent time period or if the social media accounts have had posts extracted before, from the last post extraction.

At block 332, the information extracted from the new posts may be organized. In some embodiments, the information may be organized based on the expertise of the authors associated with the social media accounts from which the information is extracted.

At block 334, the organized data may be provided according to the expertise of the authors associated with the social media accounts. In some embodiments, the information may be provided through a webpage.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

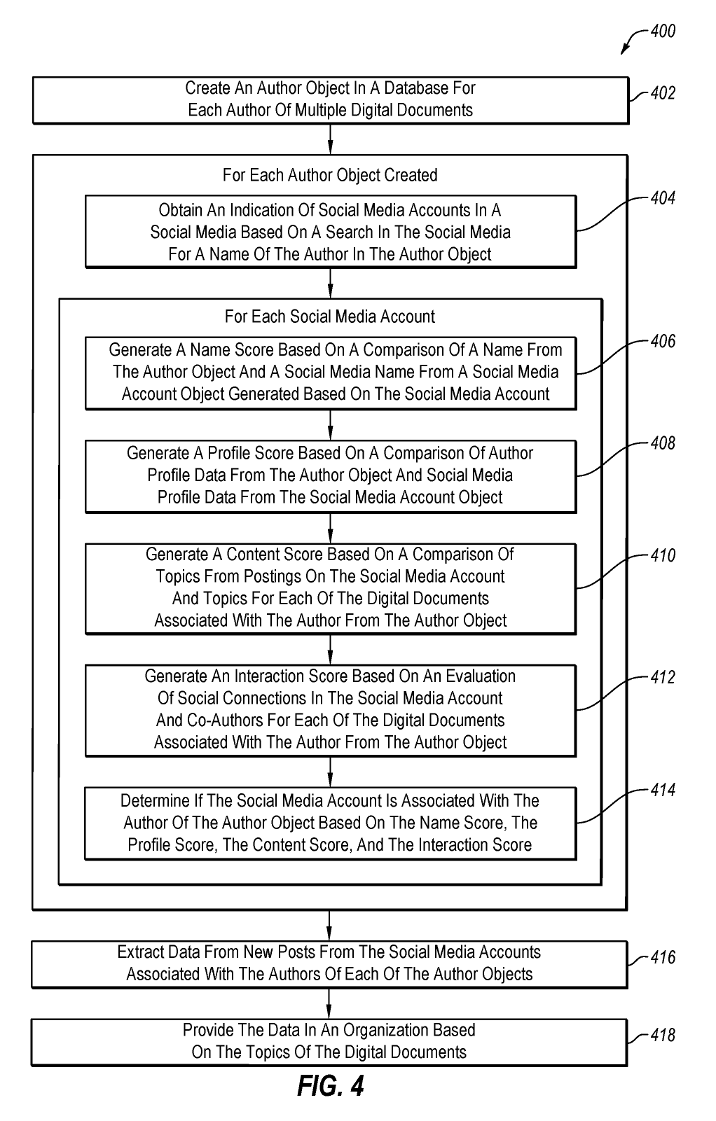

FIG. 4 is a flowchart of an example method 400 of information identification and extraction, according to at least one embodiment described herein. In some embodiments, one or more of the operations associated with the method 400 may be performed by the information collection system 110. Alternately or additionally, the method 400 may be performed by any suitable system, apparatus, or device. For example, the processor 610 of the system 600 of FIG. 6 may perform one or more of the operations associated with the method 400. Although illustrated with discrete blocks, the steps and operations associated with one or more of the blocks of the method 400 may be divided into additional blocks, combined into fewer blocks, or eliminated, depending on the desired implementation.

The method 400 may begin at block 402 where an author object may be created in a database for each author of multiple digital documents. The multiple digital documents may be obtained from one or more sources. In some embodiments, the author profile data may include one or more of a title of the author, an affiliation of the author, an expertise of the author, and a location of the author. In some embodiments, creating the author object may include extracting the name, the author profile data, and the co-authors from the digital documents.

At block 404, an indication of social media accounts in a social media may be obtained. The indication may be based on a search in the social media for a name of the author in the author object.

At block 406, a name score may be generated based on a comparison of a name from the author object and a social media name from a social media account object generated based on the social media account.

At block 408, a profile score may be generated based on a comparison of author profile data from the author object and social media profile data from the social media account object. In some embodiments, comparison of the author profile data and the social media profile data may include constructing an author vector using the author profile data, constructing a social media vector using the social media profile data, and calculating a similarity between the author vector and the social media vector, wherein the calculated similarity is the profile score.

At block 410, a content score may be generated based on a comparison of topics from postings on the social media account and topics for each of the digital documents associated with the author from the author object.

At block 412, an interaction score may be generated based on an evaluation of social connections in the social media account and co-authors for each of the digital documents associated with the author from the author object.

At block 414, it may be determined if the social media account is associated with the author of the author object based on the name score, the profile score, the content score, and the interaction score. In some embodiments, determining if the social media account is associated with the author of the author object based on the name score, the profile score, the content score, and the interaction score may include assigning each of the name score, the profile score, the content score, and the interaction score a weight. The determining may further include linearly combining the weighted name score, the weighted profile score, the weighted content score, and the weighted interaction score, and applying the linear combination to a machine learning algorithm to determine if the social media account is associated with the author of the author object.

At block 416, data may be extracted from new posts from the social media accounts associated with the authors of each of the author objects. At block 418, the data in an organization based on the topics of the digital documents may be provided.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 400 may further include determining the topics from the postings on the social media account. In some embodiments, determining the topics may include removing the postings shorter than a threshold number of words and obtaining content from embedded links in the postings. Determining the topics may further include aggregating the content and determining topic distribution of the aggregating content.

In some embodiments, the method 400 may further include obtaining the multiple digital documents from one or more sources and determining topics of each of the digital documents using a topic model analysis.

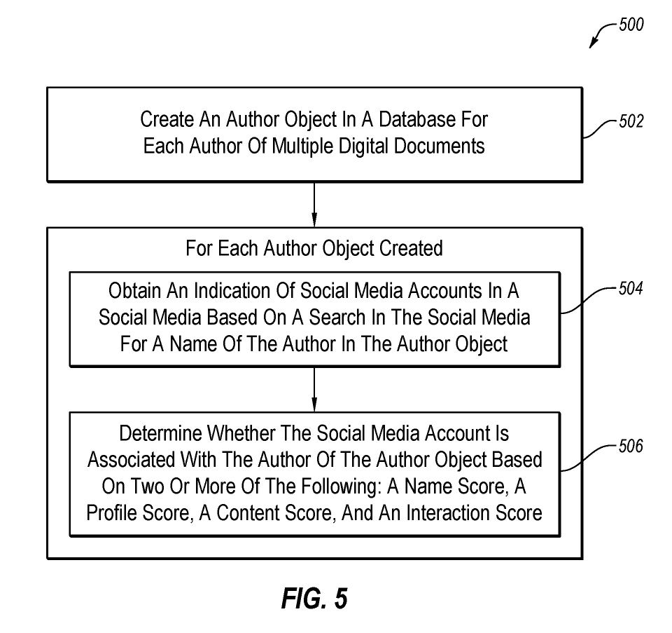

FIG. 5 is a flowchart of an example method 500 of information identification and extraction, according to at least one embodiment described herein. In some embodiments, one or more of the operations associated with the method 500 may be performed by the information collection system 110. Alternately or additionally, the method 500 may be performed by any suitable system, apparatus, or device. For example, the processor 610 of the system 600 of FIG. 6 may perform one or more of the operations associated with the method 500. Although illustrated with discrete blocks, the steps and operations associated with one or more of the blocks of the method 500 may be divided into additional blocks, combined into fewer blocks, or eliminated, depending on the desired implementation.

The method 500 may begin at block 502 where an author object may be created in a database for each author of multiple digital documents. The multiple digital documents may be obtained from one or more sources. In some embodiments, the author profile data may include one or more of a title of the author, an affiliation of the author, an expertise description of the author, and a location of the author. In some embodiments, creating the author object may include extracting the name, the author profile data, and the co-authors from the digital documents.

At block 504, an indication may be obtained of social media accounts in a social media based on a search in the social media for a name of the author in the author object.

At block 506, it may be determined whether the social media account is associated with the author of the author object based on two or more of the following: a name score, a profile score, a content score, and an interaction score.

In some embodiments, determining if the social media account is associated with the author of the author object based on the name score, the profile score, the content score, and the interaction score includes assigning each of the name score, the profile score, the content score, and the interaction score a weight and linearly combining the weighted name score, the weighted profile score, the weighted content score, and the weighted interaction score. Determining may also include applying the linear combination to a machine learning algorithm to determine if the social media account is associated with the author of the author object.

In some embodiments, the name score may be generated based on a comparison of a name from the author object and a social media name from a social media account object generated based on the social media account.

In some embodiments, the profile score may be generated based on a comparison of author profile data from the author object and social media profile data from the social media account object. In some embodiments, comparison of the author profile data and the social media profile data may include constructing an author vector using the author profile data, constructing a social media vector using the social media profile data, and calculating a similarity between the author vector and the social media vector. In some embodiments, the calculated similarity may be the profile score.

In some embodiments, the content score may be generated based on a comparison of topics from postings on the social media account and topics for each of the digital documents associated with the author from the author object.

In some embodiments, the interaction score may be generated based on an evaluation of social connections in the social media account and co-authors for each of the digital documents associated with the author from the author object.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 500 may further include determining the topics from the postings on the social media account. In some embodiments, determining the topics includes removing the postings shorter than a threshold number of words, obtaining content from embedded links in the postings, aggregating the content, and determining topic distribution of the aggregating content.

FIG. 6 illustrates an example system 600, according to at least one embodiment described herein. The system 600 may include any suitable system, apparatus, or device configured to test software. The system 600 may include a processor 610, a memory 620, a data storage 630, and a communication device 640, which all may be communicatively coupled. The data storage 630 may include various types of data, such as author objects and social media account objects.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of network or physical locations that are configured to perform individually or collectively any number of operations described herein. In some embodiments, the processor 610 may interpret and/or execute program instructions and/or process data stored in the memory 620, the data storage 630, or the memory 620 and the data storage 630. In some embodiments, the processor 610 may fetch program instructions from the data storage 630 and load the program instructions into the memory 620.

After the program instructions are loaded into the memory 620, the processor 610 may execute the program instructions, such as instructions to perform the flow 200 and/or the methods 300 and 400 of FIGS. 2, 3, and 4, respectively. For example, the processor 610 may create the author objects and the social media account objects using information from publication systems and social media systems, respectively. The processor 610 may compare the information from the author objects and the social media account objects to identify social media accounts associated with authors from the author objects.

The memory 620 and the data storage 630 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

The communication unit 640 may include any component, device, system, or combination thereof that is configured to transmit or receive information over a network. In some embodiments, the communication unit 640 may communicate with other devices at other locations, the same location, or even other components within the same system. For example, the communication unit 640 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 640 may permit data to be exchanged with a network and/or any other devices or systems described in the present disclosure. For example, the communication unit 640 may allow the system 600 to communicate with other systems, such as the publication systems 120, the social media systems 130, and the device 140 of FIG. 1.

Modifications, additions, or omissions may be made to the system 600 without departing from the scope of the present disclosure. For example, the data storage 630 may be multiple different storage mediums located in multiple locations and accessed by the processor 610 through a network.

As indicated above, the embodiments described herein may include the use of a special purpose or general purpose computer (e.g., the processor 610 of FIG. 6) including various computer hardware or software modules, as discussed in greater detail below. Further, as indicated above, embodiments described herein may be implemented using computer-readable media (e.g., the memory 620 or data storage 630 of FIG. 6) for carrying or having computer-executable instructions or data structures stored thereon.

As used herein, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computer implemented method of information identification and extraction, the method comprising:
creating an author object in a database for each author of a plurality of digital documents;
for each author object created, the computer implemented method includes:
obtaining an indication of social media accounts in a social media based on a search in the social media for a name of the author in the author object; and
for each social media account obtained through the search of the social media, the computer implemented method includes:
generating a name score based on a comparison of a name from the author object and a social media name from a social media account object generated based on the social media account;
generating a profile score based on a comparison of author profile data from the author object and social media profile data from the social media account object;
generating a content score based on a comparison of topics from postings on the social media account and topics for each of the digital documents associated with the author from the author object;
generating an interaction score based on an evaluation of social connections in the social media account and co-authors for each of the digital documents associated with the author from the author object; and
determining if the social media account is associated with the author of the author object based on the name score, the profile score, the content score, and the interaction score;
extracting data from new posts from the social media accounts associated with the authors of each of the author objects; and
providing the data in an organization based on the topics of the digital documents.

2. The computer implemented method of claim 1, wherein the author profile data includes one or more of a title of the author, an affiliation of the author, an expertise of the author, and a location of the author.

3. The computer implemented method of claim 1, wherein comparison of the author profile data and the social media profile data includes:
constructing an author vector using the author profile data;
constructing a social media vector using the social media profile data; and
calculating a similarity between the author vector and the social media vector, wherein the calculated similarity is the profile score.

4. The computer implemented method of claim 1, further comprising determining the topics from the postings on the social media account, wherein determining the topics includes:
removing the postings shorter than a threshold number of words;
obtaining content from embedded links in the postings;
aggregating the content; and
determining topic distribution of the aggregating content.

5. The computer implemented method of claim 1, wherein determining if the social media account is associated with the author of the author object based on the name score, the profile score, the content score, and the interaction score includes:
assigning each of the name score, the profile score, the content score, and the interaction score a weight;
linearly combining the weighted name score, the weighted profile score, the weighted content score, and the weighted interaction score; and
applying the linear combination to a machine learning algorithm to determine if the social media account is associated with the author of the author object.

6. The computer implemented method of claim 1, further comprising:
obtaining the plurality of digital documents from one or more web sites; and
determining a topic of each of the digital documents using a topic model analysis.

7. The computer implemented method of claim 1, wherein creating the author object includes extracting the name, the author profile data, and the co-authors from the digital documents.

8. A non-transitory computer-readable storage media including computer-executable instructions configured to cause a system to perform operations, the operations comprising:
create an author object in a database for each author of a plurality of digital documents;
for each author object created, the operations include:
obtain an indication of social media accounts in a social media based on a search in the social media for a name of the author in the author object; and
for each social media account obtained through the search of the social media, determine whether the social media account is associated with the author of the author object based on two or more of the following: a name score, a profile score, a content score, and an interaction score, wherein:
the name score is generated based on a comparison of a name from the author object and a social media name from a social media account object generated based on the social media account,
the profile score is generated based on a comparison of author profile data from the author object and social media profile data from the social media account object,
the content score is generated based on a comparison of topics from postings on the social media account and topics for each of the digital documents associated with the author from the author object, and
the interaction score is generated based on an evaluation of social connections in the social media account and co-authors for each of the digital documents associated with the author from the author object.

9. The non-transitory computer-readable storage media of claim 8, wherein the author profile data includes one or more of a title of the author, an affiliation of the author, an expertise of the author, and a location of the author.

10. The non-transitory computer-readable storage media of claim 8, wherein comparison of the author profile data and the social media profile data includes:
construct an author vector using the author profile data;
construct a social media vector using the social media profile data; and
calculate a similarity between the author vector and the social media vector, wherein the calculated similarity is the profile score.

11. The non-transitory computer-readable storage media of claim 8, wherein the operations further comprise determine the topics from the postings on the social media account, wherein determine the topics includes:
remove the postings shorter than a threshold number of words;
obtain content from embedded links in the postings;
aggregate the content; and
determine topic distribution of the aggregated content.

12. The non-transitory computer-readable storage media of claim 8, wherein creation of the author object includes extract the name, the author profile data, and the co-authors from the digital documents.

13. The non-transitory computer-readable storage media of claim 8, wherein determine if the social media account is associated with the author of the author object based on the name score, the profile score, the content score, and the interaction score includes:
assign each of the name score, the profile score, the content score, and the interaction score a weight;
linearly combine the weighted name score, the weighted profile score, the weighted content score, and the weighted interaction score; and
apply the linear combination to a machine learning algorithm to determine if the social media account is associated with the author of the author object.

14. The non-transitory computer-readable storage media of claim 8, wherein create the author object includes extracting the name, the author profile data, and the co-authors from the digital documents.

15. A computer implemented method of information identification and extraction, the method comprising:
creating an author object in a database for each author of a plurality of digital documents;
for each author object created, the computer implemented method includes:
obtaining an indication of social media accounts in a social media based on a search in the social media for a name of the author in the author object; and
for each social media account obtained through the search of the social media, determining whether the social media account is associated with the author of the author object based on two or more of the following: a name score, a profile score, a content score, and an interaction score, wherein:
the name score is generated based on a comparison of a name from the author object and a social media name from a social media account object generated based on the social media account,
the profile score is generated based on a comparison of author profile data from the author object and social media profile data from the social media account object,
the content score is generated based on a comparison of topics from postings on the social media account and topics for each of the digital documents associated with the author from the author object, and
the interaction score is generated based on an evaluation of social connections in the social media account and co-authors for each of the digital documents associated with the author from the author object.

16. The computer implemented method of claim 15, wherein the author profile data includes one or more of a title of the author, an affiliation of the author, an expertise of the author, and a location of the author.

17. The computer implemented method of claim 15, wherein comparison of the author profile data and the social media profile data includes:
constructing an author vector using the author profile data;
constructing a social media vector using the social media profile data; and
calculating a similarity between the author vector and the social media vector, wherein the calculated similarity is the profile score.

18. The computer implemented method of claim 15, further comprising determining the topics from the postings on the social media account, wherein determining the topics includes:
removing the postings shorter than a threshold number of words;
obtaining content from embedded links in the postings;
aggregating the content; and
determining topic distribution of the aggregated content.

19. The computer implemented method of claim 15, wherein determining if the social media account is associated with the author of the author object based on the name score, the profile score, the content score, and the interaction score includes:
assigning each of the name score, the profile score, the content score, and the interaction score a weight;
linearly combining the weighted name score, the weighted profile score, the weighted content score, and the weighted interaction score; and
applying the linear combination to a machine learning algorithm to determine if the social media account is associated with the author of the author object.

20. The computer implemented method of claim 15, wherein creating the author object includes extracting the name, the author profile data, and the co-authors from the digital documents.
